(19) United States
(12) Patent Application Publication
(10) Pub. No.: US 2007/0000371 A1
(43) Pub. Date: Jan. 4, 2007

(54) Tone synthesis apparatus and method

(75) Inventor: Eiji Akazawa, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 11/480,092

(22) Filed: Jun. 30, 2006

(30) Foreign Application Priority Data
Jul. 4, 2005 (JP) 2005-195104

(51) Int. Cl. G10H 7/00

(52) U.S. Cl. 84/604

(57) ABSTRACT

Dynamics values are acquired intermittently at predetermined time intervals, and waveform data corresponding to the acquired dynamics values are acquired. The thus-acquired waveform data are synthesized to generate a tone waveform of a range corresponding to a sustain portion of a tone. Because waveform data to be used are acquired, from among a plurality of prestored waveform data for sustain tones, intermittently at predetermined time intervals in accordance with dynamics values and a tone is synthesized using the acquired waveform data, not only tone synthesis processing can be performed on a sustain portion of a tone, in accordance with the input dynamics values, with a reduced burden on a control section, but also the tone characteristic can be variably controlled in accordance with the input dynamics values. Thus, it is possible to synthesize a high-quality tone faithfully representing tone color variation such as that by a vibrato rendition style.

### BACKGROUND OF THE INVENTION

The present invention relates generally to tone synthesis apparatus and methods for synthesizing tones, voices or other desired sounds on the basis of waveform sample data stored in a waveform memory or the like, and programs therefor. More particularly, the present invention relates to a tone synthesis apparatus and method for synthesizing a tone of high quality whose waveform varies in its sustain portion in accordance with tone volume level information (or “dynamics value” information), and a program therefor. Further, the present invention relates to a tone synthesis apparatus and method for synthesizing a tone waveform with high quality based on a vibrato or other rendition style involving pitch variation in a sustain portion, such that the waveform varies in accordance with tone volume level information (dynamics value), as well as a program therefor.

There have been popularly known tone synthesis apparatus based on the so-called “waveform memory readout” method, in which waveform sample data, encoded by a desired encoding technique, such as the PCM (Pulse Code Modulation), DPCM (Differential PCM) or ADPCM (Adaptive Differential PCM), are prestored in a waveform memory and a tone is synthesized by reading out the prestored waveform sample data at a rate corresponding to a desired tone pitch. With such tone synthesis apparatus, it has been conventional to prestore, per musical instrument name or tone color type (e.g., “piano” or “violin”), a variety of different waveforms in corresponding relationship to pitch various factors, such as various pitches, pitch ranges or pitch modulation amounts, or in corresponding relationship to tone volume level variation factors, such as dynamics, velocity or touch. In such cases, an optimal one of the prestored waveforms is selected in accordance with a pitch shift factor or tone volume level variation factor detected during a reproductive performance, so as to synthesize a tone of high quality. Examples of such tone synthesis apparatus are disclosed in Japanese Patent Publication Nos. 2580761 and 2970438.

Further, when a tone corresponding to a given note is to be reproduced in a pitch-modulated rendition style, such as a vibrato or bend rendition style, where the pitch of the tone varies continuously during audible reproduction of the tone, a typical example of the conventional tone synthesis apparatus synthesizes a tone by modulating the pitch of a non-pitch-modulated waveform in accordance with pitch modulation information input in real time. Further, Japanese Patent Application Laid-open Nos. HEI-11-167382, 2000-56773, 2000-122664 and 2001-100757 disclose a technique for achieving tone synthesis with higher quality by extracting a plurality of waveforms (i.e., waveform segments) from dispersed points of one vibrato cycle range of a continuous vibrato-modulated waveform sampled on the basis of an actual performance of a natural musical instrument and then storing the thus extracted waveforms as template waveforms. In reproduction, the disclosed technique sequentially reads out the template waveforms in a repetitive (or “looped”) fashion and crossfade-synthesizes the read-out template waveforms, to thereby reproduce a high-quality vibrato rendition style waveform.

The prior art apparatus disclosed in the above-identified No. 2580761 or 2970438 publication is arranged to synthesize tones while sequentially selecting waveform data to be used by switching between prestored waveform sample data in accordance with dynamics information indicative of level variation amounts corresponding to expression control, velocity control, etc. However, in synthesizing tones while sequentially selecting waveform data to be used by switching between prestored waveform sample data in accordance with dynamics information as noted above, the waveform sample data switching tends to occur very frequently even for a sustain portion of a tone (or sustain tone portion) because the prior art apparatus constantly acquires the dynamics information to make the waveform sample data switching. If the waveform sample data switching occurs very frequently as in the prior art, rapid waveform variation tends to occur, which may undesirable give an unstable impression although what is being reproduced is a sustain portion of a tone. Further, whereas it is generally common perform interpolating arithmetic operations on waveforms in order to absorb such rapid waveform variation, the frequent waveform switching would impose a great burden on the interpolating arithmetic operations.

Further, the prior art apparatus disclosed in the above-identified Nos. HEI-11-167382, 2000-56773, 2000-122664 and 2001-100757 publications, each of which permits high-quality tone synthesis, are not arranged to allow a tone characteristic to be modified or changed, in accordance with input dynamics information, at a desired time during tone synthesis.

### SUMMARY OF THE INVENTION

In view of the foregoing, it is an object of the present invention to provide a tone synthesis apparatus and method and program therefor which can perform tone synthesis processing, responsive to input dynamics values, for a sustain portion of a tone with a reduced burden on a control section. The present invention also seeks to provide a tone synthesis apparatus and method and program therefor which can variably control a characteristic of a tone in accordance with input dynamics values when synthesizing a tone waveform, varying in pitch over time and reflecting a characteristic of a rendition style like a vibrato, pitch bend or the like, with a high-quality characteristic in such a manner that a color of the tone too can be varied subtly. The present invention also seeks to provide a tone synthesis apparatus and method and program therefor which can perform vibrato depth control with high quality.

According to a first aspect of the present invention, there is provided an improved tone synthesis apparatus, which comprises: a storage section that stores therein waveform data sets for sustain tones in association with dynamics values; an acquisition section that, when a sustain tone is to be generated, acquires, intermittently at predetermined time intervals, dynamics values for controlling the sustain tone to be generated; and a tone generation section that acquires, from the storage section, the waveform data set corresponding to the dynamics value acquired by the acquisition section and generates a tone waveform of the sustain tone on the basis of the acquired waveform data set.

According to the present invention, when a tone of a range corresponding to a sustain portion of a tone (i.e., sustain tone portion), dynamics values are acquired intermittently at predetermined time intervals, and a waveform data set for a sustain tone, corresponding to each of the acquired dynamics values, is selected from the storage section having prestored therein waveform data sets for sustain tones in association with dynamics values. The waveform data sets thus selected in accordance with the dynamics values acquired intermittently at predetermined tine intervals are synthesized to generate a tone waveform of a range corresponding to the sustain tone portion. Because the waveform data to be used are acquired, from among the plurality of prestored waveform data sets for sustain tones, intermittently at predetermined time intervals in accordance with the dynamics values and a tone is synthesized using the acquired waveform data, not only tone synthesis processing can be performed on the sustain tone portion, in accordance with the input dynamics values, with a reduced burden on a control section, but also the tone characteristic can be variably controlled in accordance with the input dynamics values. In this way, the present invention can synthesize a high-quality tone faithfully representing tone color variation, like that attained by a vibrato rendition style, in a sustain tone portion.

According to a second aspect of the present invention, there is provided an improved tone synthesis apparatus, which comprises: a storage section that stores therein a plurality of units, each including a plurality of waveform data sets corresponding to different pitch shifts, in association with dynamics values; a dynamics value acquisition section that acquires, intermittently at predetermined time intervals, dynamics values for controlling a tone to be generated; a pitch modulation information acquisition section that acquires pitch modulation information for controlling pitch modulation of the tone to be generated; and a tone generation section that selects, from the storage section, the unit corresponding to the dynamics value acquired by the acquisition section, acquires, from the selected unit, the waveform data set corresponding to the pitch modulation information acquired by the pitch modulation information acquisition section, and generates a tone waveform on the basis of the acquired waveform data set.

With the arrangements that waveform data corresponding to the acquired pitch modulation information are acquired from one of the plurality of units each including a plurality of waveform data sets corresponding to different pitch shifts, and a tone waveform is generated on the basis of the acquired waveform data, the present invention can synthesize a tone waveform, varying over time in pitch like a vibrato or pitch bend, with a high-quality characteristic in such a manner that its tone color can also be subtly varied.

According to a third aspect of the present invention, there is provided an improved tone synthesis apparatus, which comprises: a storage section that stores therein a plurality of units, each including a plurality of waveform data sets for achieving a characteristic to cause variation in pitch over time, in association with dynamics values; an acquisition section that, when a tone with a characteristic to cause variation in pitch over time is to be generated, acquires dynamics values for controlling the tone to be generated; and a tone generation section that acquires, from the storage section, the waveform data set of the unit corresponding to the dynamics value acquired by the acquisition section and generates, on the basis of the acquired waveform data sets, a tone waveform with a characteristic to cause variation in pitch over time. Because a tone waveform is generated on the basis of the waveform data sets of the unit corresponding to the acquired dynamics values, the present invention can synthesize a tone waveform, varying over time in pitch like a vibrato or pitch bend, with a high-quality characteristic in such a manner that its tone color can also be subtly varied.

According to a fourth aspect of the present invention, there is provided an improved tone synthesis apparatus, which comprises: a storage section that stores therein a unit including a plurality of waveform data sets for achieving a vibrato characteristic to cause variation in pitch over time; an acquisition section that acquires depth control information for controlling a vibrato depth; a tone generation section that acquires, from the storage section, the plurality of waveform data sets of the unit and generates a tone waveform with a vibrato characteristic on the basis of the acquired plurality of waveform data sets of the unit and the depth control information acquired by the acquisition section, wherein, when control is to be performed to decrease the vibrato depth in accordance with the acquired depth control information, the tone generation section generates the tone waveform without using waveform data, corresponding to a great pitch shift, of the plurality of waveform data sets of the unit. Namely, a tone waveform is generated which has been controlled, in accordance with the depth control information, so that the vibrato depth is decreased, without using waveform data corresponding to a great pitch shift, of the plurality of waveform data sets of the unit. In this way, the vibrato depth can be controlled with high quality.

Namely, the present invention is characterized in that waveform data to be used are selected, on the basis of acquired dynamics information, from among prestored waveform data sets of various different tone colors and a tone is synthesized using the selected waveform data. Thus, when a tone synthesis corresponding to input dynamics values are to be performed on a sustain portion of a tone, the present invention can not only avoid rapid waveform variation and achieve waveform stabilization but also secure controllability of a tone characteristic during synthesis of a tone, through tone synthesis processing with a significantly reduced burden on a control section. As a result, the present invention can synthesize a high-quality tone faithfully representing tone color variation, as with a vibrato rendition style, in a sustain. tone portion.

The present invention may be constructed and implemented not only as the apparatus invention as discussed above but also as a method invention. Also, the present invention may be arranged and implemented as a software program for execution by a processor such as a computer or DSP, as well as a storage medium storing such a software program. Further, the processor used in the present invention may comprise a dedicated processor with dedicated logic built in hardware, not to mention a computer or other general-purpose type processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the objects and other features of the present invention, its preferred embodiments will be described hereinbelow in greater detail with reference to the accompanying drawings, in which:

FIG. 1 is a block diagram showing an exemplary general hardware setup of an electronic musical instrument to which is applied a tone synthesis apparatus in accordance with an embodiment of the present invention;

FIG. 2 is a functional block diagram explanatory of a tone synthesis function of the tone synthesis apparatus;

FIG. 3 is a conceptual diagram showing waveform data stored in a database and applicable to a sustain portion of a tone, of which (a) shows a data structure of the database and (b)-(d) show examples of various units;

FIG. 4 is a flow chart showing an example operational sequence of normal dynamics body synthesis processing;

FIG. 5 is a schematic diagram explanatory of details of a tone synthesis procedure carried out by the normal dynamics body synthesis processing;

FIG. 6 is a flow chart showing an example operational sequence of manual vibrato (or bend) body synthesis processing;

FIG. 7 is a diagram explanatory of details of a tone synthesis procedure carried out by the manual vibrato (or bend) body synthesis processing;

FIG. 8 is a flow chart showing an example operational sequence of auto vibrato body synthesis processing;

FIG. 9 is a schematic diagram explanatory of a procedure for processing a vibrato speed in the auto vibrato body synthesis processing; and

FIG. 10 is a schematic diagram explanatory of a procedure for processing a vibrato depth in the auto vibrato body synthesis processing.

### DETAILED DESCRIPTION OF THE INVENTION

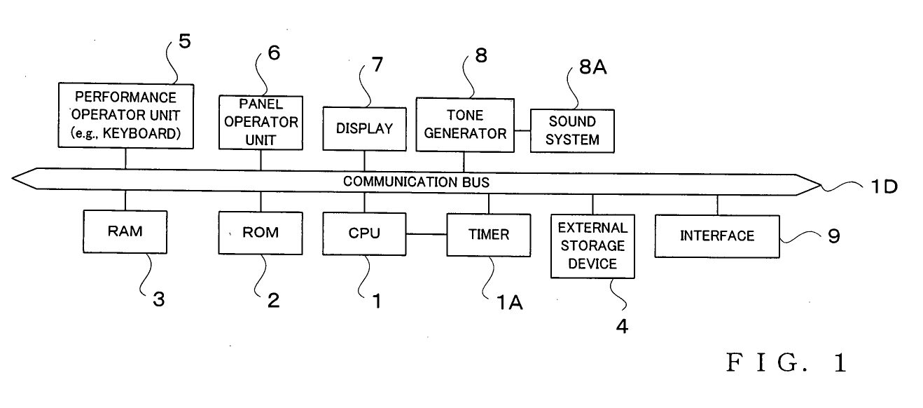

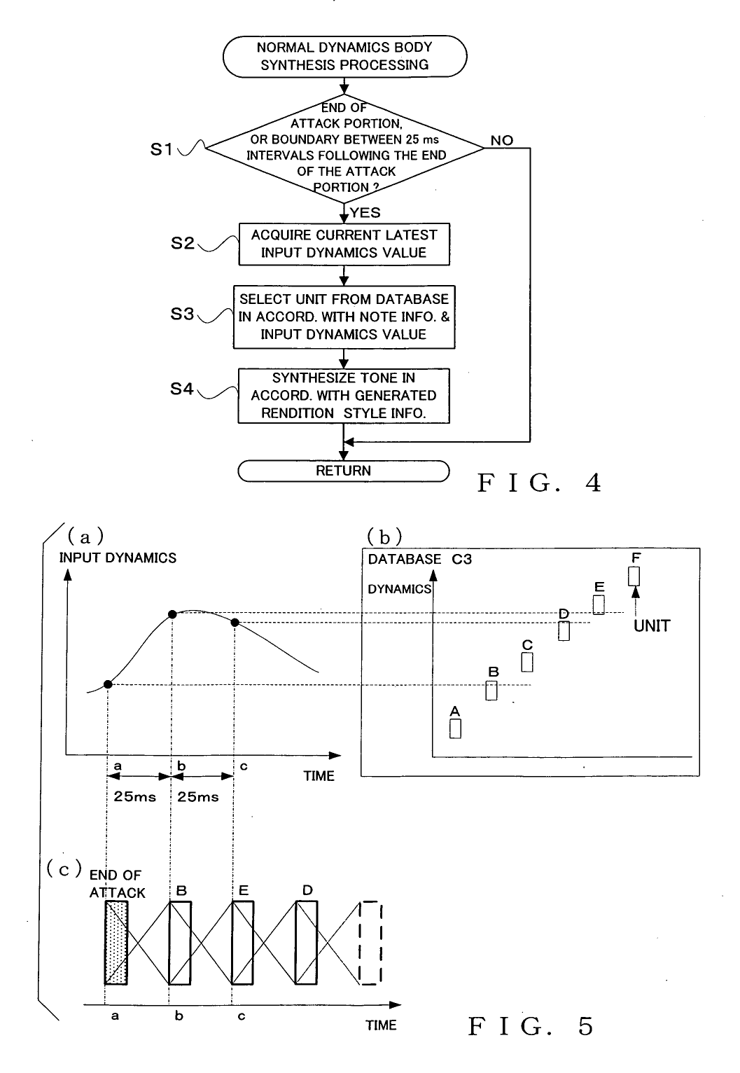

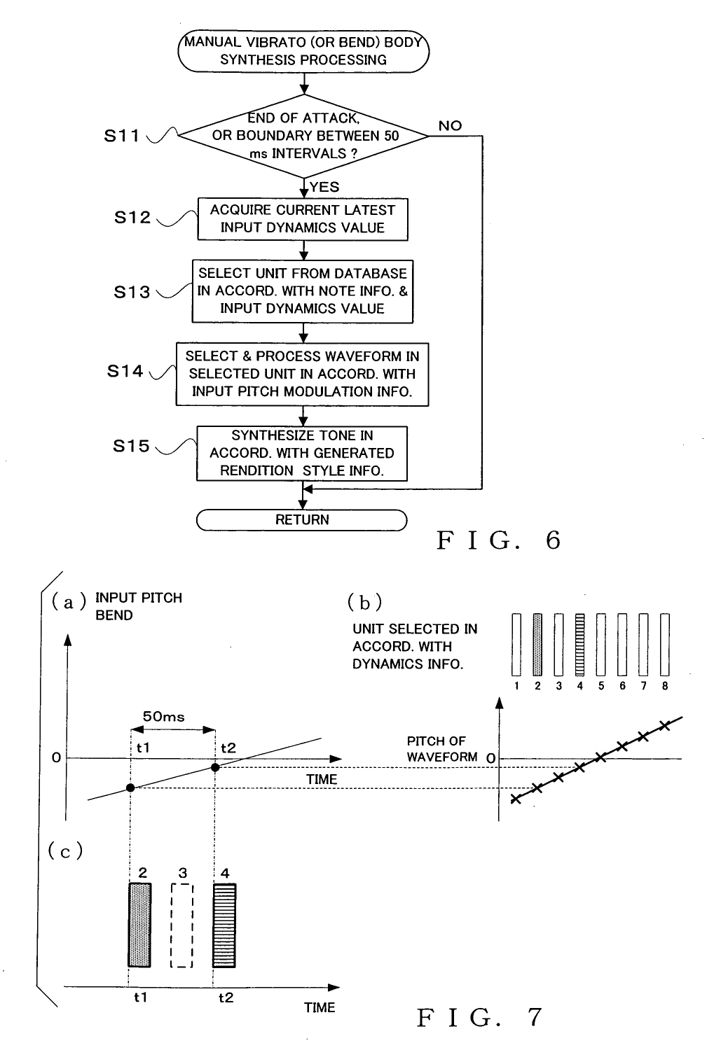

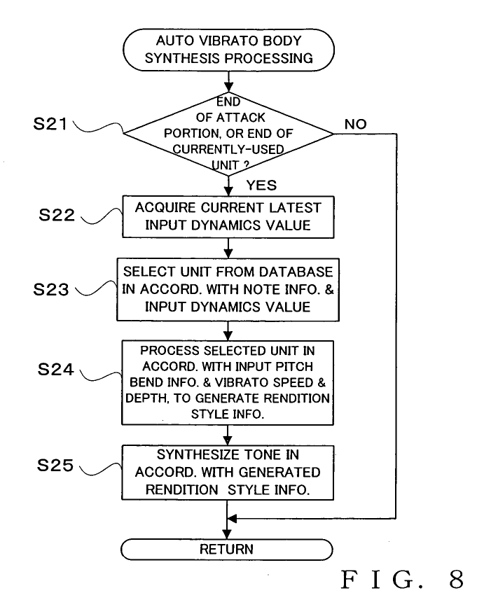

FIG. 1 is a block diagram showing an exemplary general hardware setup of an electronic musical instrument to which is applied a tone synthesis apparatus in accordance with an embodiment of the present invention. The electronic musical instrument illustrated here has a tone synthesis function for electronically generating tones on the basis of performance information (e.g., performance event data, such as note-on event and note-off event data, and various control data, such as dynamics information, pitch event information, vibrato speed information and vibrato depth information) supplied in accordance with a performance progression based on operation, by a human player, of a performance operator unit 5, and for automatically generating tones on the basis of pre-created performance information sequentially supplied in accordance with a performance progression. Further, during execution of the above-mentioned tone synthesis function, the tone synthesis apparatus selects, for a sustain portion (also called “body portion”) of a tone, waveform sample data (hereinafter simply referred to as “waveform data”) to be newly used on the basis of dynamics included in the performance information and synthesizes a tone in accordance with the selected waveform data so that a tone of a bend rendition style or vibrato rendition style in particular can be reproduced with high quality as a tone of the sustain portion (i.e., sustain tone portion). Such tone synthesis processing on a sustain tone portion comprises “normal dynamics body synthesis processing” (to be later described with reference to FIGS. 4 and 5) as a first embodiment of the tone synthesis processing, “manual vibrato body synthesis processing” (to be later described with reference to FIGS. 6 and 7) as a second embodiment of the tone synthesis processing, “auto vibrato body synthesis processing” (to be later described with reference to FIGS. 8 to 10) as a third embodiment of the tone synthesis processing, etc. These embodiments will be described later with reference to the respective figures.

Although the electronic musical instrument employing the tone synthesis apparatus to be described below may include other hardware than those described here, it will hereinafter be described in relation to a case where only necessary minimum resources are used. The electronic musical instrument will be described hereinbelow as employing a tone generator that uses a tone waveform control technique called “AEM (Articulation Element Modeling)” (so-called “AEM tone generator”). The AEM technique is intended to perform realistic reproduction and reproduction control of various rendition styles etc. faithfully expressing tone color variation based on various rendition styles or articulation peculiar to various natural musical instruments, by prestoring, as waveform data corresponding to rendition styles peculiar to various musical instruments, entire waveforms corresponding to various rendition styles (hereinafter referred to as “rendition style modules”) in partial sections or portions, such as an attack portion, release portion, sustain tone portion or joint portion, etc. of each individual tone and then time-serially combining a plurality of the prestored rendition style modules to thereby form one or more successive tones.

The electronic musical instrument shown in FIG. 1 is implemented using a computer, where various “tone synthesis processing” (see FIGS. 4-10) for realizing the above-mentioned tone synthesis function is carried out by the computer executing respective predetermined programs (software). Of course, these processing may be implemented by microprograms to be executed by a DSP (Digital Signal Processor), rather than by such computer software. Alternatively, the processing may be implemented by a dedicated hardware apparatus having discrete circuits or integrated or large-scale integrated circuit incorporated therein.

In the electronic musical instrument of FIG. 1, various operations are carried out under control of a microcomputer including a microprocessor unit (CPU) 1, a read-only memory (ROM) 2 and a random access memory (RAM) 3. The CPU 1 controls behavior of the entire electronic musical instrument. To the CPU 1 are connected, via a communication bus (e.g., data and address bus) iD, the ROM 2, RAM 3, external storage device 4, performance operator unit 5, panel operator unit 6, display device 7, tone generator 8 and interface 9. Also connected to the CPU 1 is a timer 1A for counting various times, for example, to signal interrupt timing for timer interrupt processes. Namely, the timer 1A generates tempo clock pulses for counting a time interval or setting a performance tempo with which to automatically perform a music piece in accordance with given music piece data. The frequency of the tempo clock pulses is adjustable, for example, via a tempo-setting switch of the panel operator unit 6. Such tempo clock pulses generated by the timer 1A are given to the CPU 1 as processing timing instructions or as interrupt instructions. The CPU 1 carries out various processes in accordance with such instructions.

The ROM 2 stores therein various programs to be executed by the CPU 1 and also store therein, as a waveform memory, various data, such as waveform data (indicative of, for example, waveforms having tone color variation based on a vibrato rendition style and the like, waveforms having straight tone colors, etc.). The RAM 3 is used as a working memory for temporarily storing various data generated as the CPU 1 executes predetermined programs, and as a memory for storing a currently-executed program and data related to the currently-executed program. Predetermined address regions of the RAM 3 are allocated to various functions and used as various registers, flags, tables, memories, etc. The external storage device 4 is provided for storing various data, such as performance information to be used as a basis of an automatic performance and waveform data corresponding to rendition styles, and various control programs, such as the “tone synthesis processing” (see FIGS. 4, 6 and 8) to be executed or referred to by the CPU 1. Where a particular control program is not prestored in the ROM 2, the control program may be prestored in the external storage device (e.g., hard disk device) 4, so that, by reading the control program from the external storage device 4 into the RAM .3, the CPU 1 is allowed to operate in exactly the same way as in the case where the particular control program is stored in the ROM 2. This arrangement greatly facilitates version upgrade of the control program, addition of a new control program, etc. The external storage device 4 may comprise any of various removable-type external recording media other than the hard disk (HD), such as a flexible disk (FD), compact disk (CD-ROM or CD-RAM), magneto-optical disk (MO) and digital versatile disk (DVD). Alternatively, the external storage device 4 may comprise a semiconductor memory.

The performance operator unit 5 is, for example, in the form of a keyboard including a plurality of keys operable to select pitches of tones to be generated and key switches provided in corresponding relation to the keys. This performance operator unit 5 can be used not only for a manual tone performance based on manual playing operation by a human player, but also as input means for selecting desired prestored performance information to be automatically performed. It should be obvious that the performance operator unit 5 may be other than the keyboard type, such as a neck-like operator unit having tone-pitch-selecting strings provided thereon. The panel operator unit 6 includes various operators, such as performance information selecting switches for selecting desired performance information to be automatically performed and setting switches for setting various performance parameters, such as a tone color and effect, to be used for a performance. Needless to say, the panel operator unit 6 may also include a numeric keypad for inputting numerical value data to be used for selecting, setting and controlling tone pitches, colors, effects, etc. to be used for a performance, a keyboard for inputting text or character data, a mouse for operating a pointer to designate a desired position on any of various screens displayed on the display device 7, and various other operators. For example, the display device 7 comprises a liquid crystal display (LCD), CRT (Cathode Ray Tube) and/or the like, which visually displays not only various screens in response to operation of the corresponding switches but also various information, such as performance information and waveform data, and controlling states of the CPU 1. The human player can readily set various performance parameters to be used for a performance and select a music piece to be automatically performed, with reference to the various information displayed on the display device 7.

The tone generator 8, which is capable of simultaneously generating tone signals in a plurality of tone generation channels, receives performance information supplied via the communication bus 1D and synthesizes tones and generates tone signals on the basis of the received performance information. Namely, as waveform data corresponding to dynamics information included in performance information are read out from the ROM 2 or external storage device 4, the read-out waveform data are delivered via the bus 1D to the tone generator 8 and buffered as necessary. Then, the tone generator 8 outputs the buffered waveform data at a predetermined output sampling frequency. Tone signals generated by the tone generator 8 are subjected to predetermined digital processing performed by a not-shown effect circuit (e.g., DSP (Digital Signal Processor)), and the tone signals having undergone the digital processing are then supplied to a sound system 8A for audible reproduction or sounding.

The interface 9, which is, for example, a MIDI interface or communication interface, is provided for communicating various information between the electronic musical instrument and external performance information generating equipment (not shown). The MIDI interface functions to input performance information of the MIDI standard from the external performance information generating equipment (in this case, other MIDI equipment or the like) to the electronic musical instrument or output performance information of the MIDI standard from the electronic musical instrument to other MIDI equipment or the like. The other MIDI equipment may be of any desired type (or operating type), such as the keyboard type, guitar type, wind instrument type, percussion instrument type or gesture type, as long as it can generate data of the MIDI format in response to operation by a user of the equipment. The communication interface is connected to a wired or wireless communication network (not shown), such as a LAN, Internet, telephone line network, via which the communication interface is connected to the external performance information generating equipment (e.g., server computer). Thus, the communication interface functions to input various information, such as a control program and performance information, from the server computer to the electronic musical instrument. Namely, the communication interface is used to download particular information, such as a particular control program or performance information, from the server computer in a case where such particular information is not stored in the ROM 2, external storage device 4 or the like. In such a case, the electronic musical instrument, which is a “client”, sends a command to request the server computer to download the particular information, such as a particular control program or performance information, by way of the communication interface and communication network. In response to the command from the client, the server computer delivers the requested information to the electronic musical instrument via the communication network. The electronic musical instrument receives the particular information via the communication interface and accumulatively stores it into the external storage device 4 or the like. In this way, the necessary downloading of the particular information is completed.

Note that where the interface 9 is in the form of a MIDI interface, the MIDI interface may be implemented by a general-purpose interface rather than a dedicated MIDI interface, such as RS232-C, USB (Universal Serial Bus) or IEEE1394, in which case other data than MIDI event data may be communicated at the same time. In the case where such a general-purpose interface as noted above is used as the MIDI interface, the other MIDI equipment connected with the electronic musical instrument may be designed to communicate other data than MIDI event data. Of course, the performance information handled in the present invention may be of any other data format than the MIDI format, in which case the MIDI interface and other MIDI equipment are constructed in conformity to the data format used.

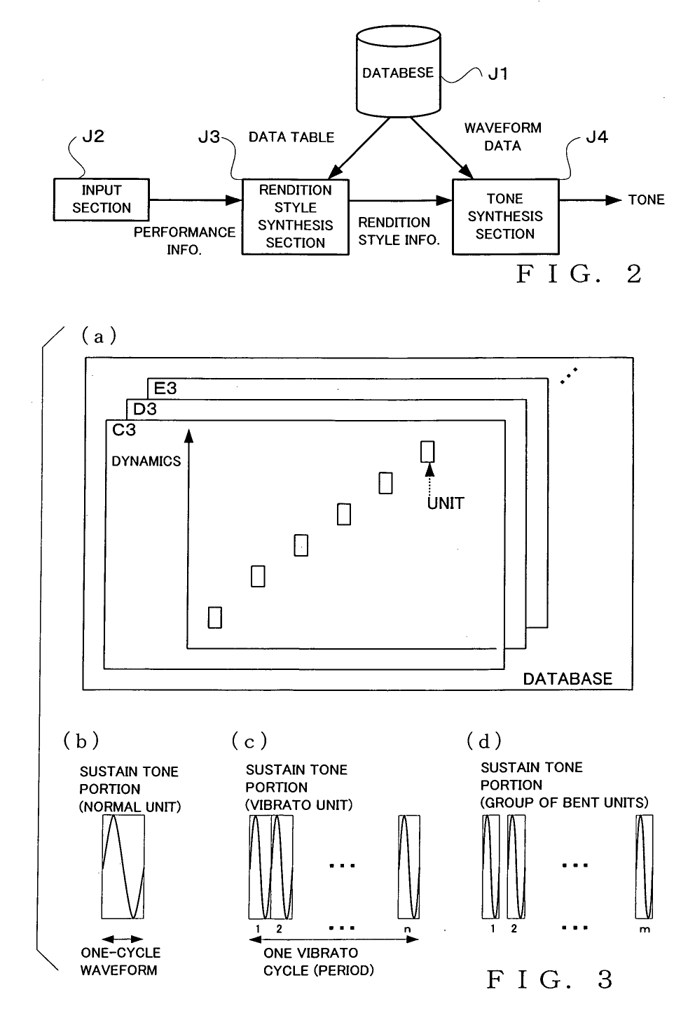

The electronic musical instrument shown in FIG. 1 is equipped with the tone synthesis function capable of successively generating tones on the basis of performance information generated in response to operation, by the human operator, of the performance operator unit 5 or performance information of the SMF (Standard MIDI File) or the like prepared in advance. Also, during execution of the tone synthesis function, the electronic musical instrument selects waveform data, which are to be newly used for a sustain tone portion, on the basis of dynamics information included in performance information supplied in accordance with a performance progression based on operation, by the human operator, of the performance operator unit 5 (or performance information supplied sequentially from a sequencer or the like), and then it synthesizes a tone in accordance with the selected waveform data. So, the following paragraph outlines the tone synthesis function of the electronic musical instrument shown in FIG. 1, with reference to FIG. 2. FIG. 2 is a functional block diagram explanatory of the tone synthesis function of the electronic musical instrument, where arrows indicate flows of data.

Once the execution of the tone synthesis function is started, performance information is sequentially supplied from an input section J2 to a rendition style synthesis section J3. The input section J2 includes the performance operator unit 5 that generates performance information in response to performance operation by the human operator, and a sequencer (not shown) that supplies, in accordance with a performance progression, performance information prestored in the ROM 2 or the like. The performance information supplied from the input section J2 includes at least performance event data, such as note-event data and note-off event data (these event data will hereinafter be generically referred to as “note information”), and control data, such as vibrato speed data and vibrato depth data. Namely, examples of the dynamics information input via the input section J2 include one generated in real time on the basis of performance operation on the performance operator unit 5 (e.g., after-touch sensor output data generated in response to depression of a key) and one based on previously stored or programmed automatic performance information. Upon receipt of performance event data, control data, etc., the rendition style synthesis section J3 generates “rendition style information”, including various information necessary for tone synthesis, by, for example, segmenting a tone, corresponding to note information, into partial sections or portions, such as an attack portion, sustain tone portion (or body portion) and release portion and identifying a start time of the sustain tone portion, and converting the received control data. During that time, the rendition style synthesis section J3 selects a later-described “unit”, to be applied to the sustain tone portion corresponding to the input dynamics information and pitch information, by reference to a data table located in a database (waveform memory) Ji and then adds, to the rendition style information, information indicative of the selected unit. Tone synthesis section J4 reads out, on the basis of the “rendition style information” generated by the rendition style synthesis section J3, waveform data (later-described normal unit, vibrato unit, or the like) from the database J1 and then performs tone synthesis on the basis of the read-out waveform data, so as to output a tone. Namely, the tone synthesis section J4 performs tone synthesis while switching between waveform data in accordance with the “rendition style information”.

Next, with reference to FIG. 3, a description will be given about data structures of waveform data which are stored in the above-mentioned database (waveform memory) J1 and which are to be applied to sustain tone portions. More specifically, (a) of FIG. 3 is a conceptual diagram showing a data structure of the database J1, and (b)-(d) of FIG. 3 is a conceptual diagram showing examples of waveform data stored, on a unit-by-unit basis, in the database J1.

In the database J1, there are stored, as “units”, sets of waveform data to be applied sustain tone portions and data related to the sets of waveform data. Each of the units is a waveform unit that can be processed as a data block during tone synthesis processing. As seen in (a) of FIG. 3, the individual “units” are associated with dynamics values, and at least one set of such units is stored for each of tone pitches (only tone pitches “C3”, “D3” and “E3” are shown in the figure for convenience of illustration). Assuming that units, each associated with 20 different dynamics values, are stored in association with 35 different tone pitches (scale notes) for each of various tone color (i.e., tone colors of musical instruments like a piano etc.), namely, for each of tone colors selectable in accordance with tone color information, a total of 700 (35×20) units are stored for that tone color in the entire database J1. Even for a same tone pitch, the units corresponding to different dynamics values may be made to represent tone waveforms having different tone color characteristics (namely, tone waveforms of different waveform shapes). Note that such units may be stored in correspondence with a group of two or more tone pitches (e.g., C3 and C#3) instead of being stored for each one of the tone pitches (scale notes).

Further, different sets of waveform data are used (stored) in association with various rendition styles (such as normal, vibrato and pitch bend rendition styles) applied to sustain tone portions, namely, in association with later-described various embodiments of the “tone synthesis processing” (to be later described in relation to FIGS. 4-10). For example, in the “normal dynamics body synthesis processing” corresponding to an ordinary or normal rendition style achieving a straight tone color characteristic that does not vary over time (see FIGS. 4 and 5), there is used a “unit” where a set of waveform data of one cycle is recorded (this unit will hereinafter be referred to as “normal unit”) as shown in (b) of FIG. 3. Here, such normal units, each representing a one-cycle waveform, are prestored for a same tone color and for each of various tone pitches in association with a plurality of dynamics values, as noted above. In this case, even if the waveform data set of the normal unit corresponding to a same dynamics value is read out repetitively, the tone color does not vary over time and presents a “straight” tone color characteristic. However, if the dynamics value differs, the normal unit to be used is changed, so that the tone color too varies subtly in accordance with the change in the normal unit.

In the “auto vibrato body synthesis processing” corresponding to an auto vibrato rendition style (see FIGS. 8 to 10), there is used a “unit” where a set of waveform data of a plurality of cycles (or a plurality of sections) is recorded for one vibrato period or cycle (such waveform data will hereinafter be referred to as “vibrato-imparted waveform data”, and the unit will hereinafter be referred to as “vibrato unit”), as shown in (c) of FIG. 3. (c) of FIG. 3 shows a set of waveform data of n cycles (or n sections) in one vibrato cycle. Tone color of the waveform data of the vibrato unit varies over time in one vibrato cycle subtly or intricately (similarly to that of an original vibrato waveform), and, of course, the waveform pitch of each of the n cycles (or sections) also varies (fluctuates) over time. The waveform data of the n cycles (or n sections) in the vibrato unit may be derived from either successive waveform data or non-successive waveform data in the original waveform. In order to make efficient use of the individual waveform data in the vibrato unit, containing pitch shifts from the original waveform, pitch information (pitch shift information) is attached to each of the waveform data of the vibrato unit. Such vibrato units are prestored for a same tone color (e.g., rendition style tone color like a vibrato rendition style of a violin) and for each of various tone pitches in association with a plurality of dynamics values, as noted above.

Further, in the “manual vibrato (or bend) body synthesis processing” corresponding to a manual vibrato (or bend) rendition style (see FIGS. 6 and 7), there are stored, in association with one dynamics value, a plurality of units (waveform data sets) corresponding to a plurality m of pitch shifts (e.g., variation in cent values), as shown in (d) of FIG. 3. For example, in association with one dynamics value corresponding to one tone pitch (note) of a given tone color, sets of waveform data, corresponding to a pitch shift of a plurality steps (e.g., at 10 cent intervals) within a range of −50 to +50 cents and containing waveform data with no pitch shift (zero cent), are stored as individual “units”. In this case, each of the units has pitch information (pitch shift information) attached to the waveform data set, so that one unit (one-cycle waveform) corresponding to a designated pitch shift can be readily searched out or selected. As the waveform data for the “manual vibrato (or bend) body synthesis processing”, the waveform data for the “auto vibrato body synthesis processing” (i.e., data of the above-mentioned vibrato unit) may be used without the dedicated waveform data as illustrated in (d) of FIG. 3 being stored. In such a case, arrangements are made to extract waveform data corresponding to a necessary pitch shift with reference to the pitch information (pitch shift information) attached to the individual one-cycle waveform data of the “vibrato unit” as illustrated in (c) of FIG. 3.

Note that the waveform data set for the normal unit is not limited to a waveform of one cycle and may comprise a waveform of two or more cycles; alternatively, a waveform of less than one cycle, such as a ½ cycle may be stored as the waveform data set of the normal unit, as conventionally known in the art. Similarly, the waveform data set for the manual vibrato (or bend) is not limited to a waveform of one cycle. Further, the waveform data set for the vibrato unit may cover a plurality of vibrato cycles rather than one vibrato cycle; alternatively, it may cover less than one vibrato cycle, such as a ½ vibrato cycle.

Among a group of data to be stored in the database J1 for each of the “units” in addition to the waveform data are the dynamics value of the original waveform data, pitch information (i.e., information indicative of an original pitch and information indicative of a pitch shift relative to the original pitch) and other information. Further, in the “vibrato unit” where all waveform data covering one vibrato cycle are recorded, there is recorded information, such as the length, average power value, etc. of the unit as information of the one vibrato cycle. Such a data group can be managed collectively as a “data table”. In the vibrato unit, as noted above, pitch information (pitch shift information) is attached to the individual waveform data so that waveform data corresponding to a desired pitch shift can be searched out.

Next, a description will be given about several embodiments of the tone synthesis processing for generating a sustain tone portion using a unit stored in the above-mentioned database J1.

### EMBODIMENT 1

First, the “normal dynamics body synthesis processing” for generating a tone using a normal unit selected in accordance with dynamics information will be described with reference to FIGS. 4 and 5. FIG. 4 is a flow chart showing an example operational sequence of the “normal dynamics body synthesis processing”, which is interrupt processing performed by the CPU 1, for example every one ms, in the electronic musical instrument in response to a time count output by the timer activated to start counting time simultaneously with a start of a performance. The “normal dynamics body synthesis processing” is performed in a mode designated for synthesizing a sustain portion of a tone with a characteristic of a “normal dynamics body” in response to operation by the human player or in response to performance information or the like. Note that a waveform of an attack portion of the tone is generated separately by not-shown attack portion waveform synthesis processing. The “normal dynamics body synthesis processing” is performed following the attack portion waveform synthesis processing.

At step S1, a determination is made as to whether a waveform currently being synthesized has reached the end of the attack portion, or whether a time corresponding to a boundary between predetermined time intervals (e.g., 25 ms intervals) has arrived after the currently-synthesized waveform reached the end of the attack portion. If the currently-synthesized waveform has not yet reached the end of the attack portion, or if a boundary between the predetermined time intervals (e.g., 25 ms intervals) has not yet arrived (NO determination at step S1), the normal dynamics body synthesis processing of FIG. 4 is brought to an end, and it will not be performed till the next interrupt timing. Namely, till the end of the attack portion, a tone of the attack portion is synthesized on the basis of the waveform data of the attack portion, and the normal dynamics body synthesis processing is not substantially performed. Similarly, for a sustain tone portion whose generation timing is not at a boundary between the 25 ms time intervals following the attack portion, substantial execution of the normal dynamics body synthesis processing is waited till the next interrupt timing without an operation of step S3 for reading out a new normal unit being carried out. Therefore, no waveform data switching responsive to an input dynamics value is made during that time. If, on the other hand, the currently-synthesized waveform has reached the end of the attack portion or a time corresponding to a boundary between the predetermined time intervals (e.g., 25 ms intervals) has arrived (YES determination at step S1), the current latest input dynamics value is acquired at step S2. The “input dynamics value” is a value indicated by the dynamics information input in the aforementioned manner. At step S3, the database is referenced, in accordance with the previously-acquired note information and the acquired input dynamics value, to select a corresponding normal unit from the database, and rendition style information is generated on the basis of the selected normal unit. Namely, the latest input dynamics value is acquired at the end of the attack portion, and a normal unit corresponding to the acquired input dynamics value is selected to generate rendition style information. At step S4, a tone is synthesized in accordance with the generated rendition style information. Namely, the “normal dynamics body synthesis processing” is arranged to generate rendition style information corresponding to the sustain tone portion every predetermined time (25 ms) during tone synthesis of the sustain tone portion started immediately following the end of the attack portion, during which time a waveform data set of a normal unit corresponding to the acquired input dynamics value is selected and a tone is synthesized in accordance with rendition style information generated on the basis of the selected waveform data set.

Now, the tone synthesis procedure by the above-described “normal dynamics body synthesis processing” (FIG. 4) will be explained with reference to FIG. 5. FIG. 5 is a schematic diagram explanatory of details of the tone synthesis procedure carried out by the above-described “normal dynamics body synthesis processing. (a) of FIG. 5 illustratively shows variation over time of the input dynamics value, (b) of FIG. 5 illustratively shows normal units stored in the database in association with dynamics values, and (c) of FIG. 1 illustratively shows a time-serial combination of normal units selected in accordance with the input dynamics values at predetermined time intervals of 25 ms. In the illustrated example of FIG. 5, let it be assumed that a tone corresponding to a pitch C3 is to be generated and that note information of the tone “C3” to be generated has already been acquired prior to formation of a waveform of the attack portion.

For example, the end of an attack portion occurs at time a, a dynamics value input at that time is acquired, and one normal unit B is selected, on the basis of the already-acquired note information (i.e., tone pitch “C3”) and newly-acquired input dynamics value, from among a plurality of normal units (A-F, . . . ) stored for the pitch (C3) in the database, to thereby generate rendition style information. Then, the waveform data set of the normal unit B is read out repetitively, on the basis of the generated rendition style information, to generate a tone waveform of the sustain portion. During that time, crossfade synthesis may be performed as necessary between the waveform at the end of the preceding attack portion and the waveform of the succeeding normal unit B; such crossfade synthesis permits smooth switching between the waveforms. The crossfade synthesis permit smooth switching between the waveforms. Then, once a boundary between the predetermined time intervals (25 ms intervals) arrives at time b, a dynamics value input at that time is acquired, and one normal unit E corresponding to the newly-acquired input dynamics value is selected from among the normal units (A-F, . . . ) stored for the pitch (C3) in the database, to thereby generate rendition style information. Then, the waveform data set of the normal unit E is read out repetitively, on the basis of the generated rendition style information, to generate a tone waveform of the sustain portion. During that time, crossfade synthesis may be performed as necessary between the waveform of the waveform of the preceding normal unit B and the waveform of the succeeding normal unit E. Then, once another boundary between the predetermined time intervals (25 ms intervals) arrives at time c, a dynamics value input at that time is acquired, and one normal unit D corresponding to the newly-acquired input dynamics value is selected from among the normal units (A-F, . . . ) stored for the pitch (C3) in the database, to thereby generate rendition style information. Then, the waveform data set of the normal unit D is read out repetitively on the basis of the generated rendition style information. During that time, crossfade synthesis may be performed as necessary between the waveform of the preceding normal unit E and the waveform of the succeeding normal unit D. In the aforementioned manner, the “normal dynamics body synthesis processing” is arranged to synthesize a tone of a sustain portion while switching, in accordance with the dynamics information, the normal unit to be used from one to another every predetermined time (25 ms). The time period over which the crossfade synthesis is performed is not limited to 25 ms and may be shorter or longer than 25 ms.

### EMBODIMENT 2

Next, a description will be given about the “manual vibrato (or bend) body synthesis processing” for generating a tone of a sustain portion, representative of a vibrato or pitch bend rendition style, by selecting a waveform in accordance with a combination of dynamics information and pitch bend information, with reference to FIGS. 6 and 7. FIG. 6 is a flow chart showing an example operational sequence of the “manual vibrato (bend) body synthesis processing”, which is also interrupt processing performed by the CPU 1, for example every one ms, in the electronic musical instrument in response to a start of a performance. The “manual vibrato (or bend) body synthesis processing” is performed in a mode designated for synthesizing a sustain portion of a tone with a “manual vibrato (or bend) body” characteristic in response to operation by the human player or in response to performance information or the like. Note that a waveform of an attack portion of the tone is generated separately by the not-shown attack portion waveform synthesis processing. The “manual vibrato (or bend) body synthesis processing” is performed following the attack portion waveform synthesis processing. In the “manual vibrato (or bend) body synthesis processing”, a pitch (note) of the tone to be generated is designated by the note information, and pitch modulation information is input in real time in response to operation, by the human operator, of a pitch modulation operator, such as a wheel.

At step S11 of FIG. 6, an operation substantially similar to step S1 of FIG. 4 is performed, except that the determination is made at time intervals of 50 ms. At next step S12, the current latest input dynamics value is acquired as at step S2. Namely, the latest input dynamics value is first acquired at the end of the attack portion and then sequentially acquired every 50 ms. At next step S13, a group of bend units (or vibrato unit) is selected from the database on the basis of the previously-acquired note information and newly acquired input dynamics value. At step S14, one bend unit (or waveform data of a (partial) section in the vibrato unit) is selected, in accordance with the currently-input (real-time) pitch modulation information, from the among selected bend units (or sections of the vibrato unit), and the selected bend unit or waveform data is processed to generate rendition style information. The processing of the selected bend unit or waveform data may include a pitch adjustment process. Namely, If no bend unit (or waveform data of a section in the vibrato unit) having a pitch shift agreeing with a pitch shift designated by the input (real-time) pitch modulation information is prestored, then a bend unit (or waveform data of a section in the vibrato unit) having a pitch shift closest to the designated pitch shift is selected, and a tone synthesis pitch (i.e., waveform-data readout address generation timing) of the selected bend unit (or waveform data) is adjusted so that the pitch shift designated by the input (real-time) pitch modulation information can be obtained. After the necessary rendition style information is generated in the aforementioned manner, a tone is synthesized in accordance with the generated rendition style information at step S15. In this case, it is preferable to perform crossfade between waveforms preceding and succeeding the unit switching so that waveform switching can be made smoothly. Note that, in the illustrated example of FIG. 6, operations of steps S14 and S15 are carried out only once when a YES determination has been made at step S11 and the acquisition of the input pitch modulation information is carried out at the same time intervals as the acquisition of the input dynamics value. However, the present invention is not so limited; for example, variation in the input pitch modulation information may be checked constantly at one ms or other suitable time intervals so that tone synthesis varying in pitch in response to the input pitch variation modulation can be performed at any time. In such a case, when a boundary between the predetermined 50 ms time intervals has not yet been reached in the example of FIG. 6 after the end of the attack portion, the operation of step S11 may be modified so as to check whether the input pitch modulation information has varied or not, and the operational sequence may be modified so that the operation of step S14 is carried out if the input pitch modulation information has varied.

Next, a description will be given about a tone synthesis procedure carried out by the “manual vibrato (bend) body synthesis processing” (see FIG. 6), with reference to FIG. 7. FIG. 7 is a diagram explanatory of details of the tone synthesis procedure by the “manual vibrato (bend) body synthesis processing”. (a) of FIG. 7 illustratively shows variation over time of a pitch bend amount designated by the pitch modulation information, (b) of FIG. 7 illustratively shows a group of bend units (or a plurality of waveform data sets in a vibrato unit) selected from the database in accordance with an input dynamics value, and pitch shift information attached to the selected group of bend units (or the selected waveform data sets), and (c) of FIG. 7 illustratively shows a time-serial combination of bend units (waveform data sets in a vibrato unit) selected in accordance with the pitch modulation information and input dynamics value acquired every predetermined time interval of 50 ms.

Assuming that time t1 is when the end of the attack portion occurs or a boundary between the predetermined time intervals (50 ms intervals) occurs following the end of the attack portion, the latest input dynamics value is acquired, and a group of bend units (or one vibrato unit) corresponding to the acquired input dynamics value is selected, in accordance with the previously-acquired note information and the acquired input dynamics value, from among a plurality of groups of bend units (or vibrato units) prestored in the database for the tone pitch in question. Then, in accordance with the current latest pitch modulation information, one bend unit (or waveform data set of a partial section of the vibrato unit) (e.g., block “2” in (c) of FIG. 7) having the pitch shift in question is selected from the group of bend units (or the one vibrato unit), to generate rendition style information. Then, crossfade synthesis is performed between a previous tone waveform (i.e., preceding waveform) and a new tone waveform (i.e., succeeding waveform) to achieve smooth switching from the preceding waveform to the succeeding waveform, in generally the same manner as set forth above. Once, after time t1, the performance arrives at time t2 coinciding with another boundary between the predetermined time intervals (50 ms intervals), the current latest input dynamics value is acquired, and a group of bend units (or one vibrato unit) corresponding to the acquired input dynamics value is selected from the database for the tone pitch in question. Then, in accordance with the current latest pitch modulation information, one bend unit (or waveform data set of a partial section of the vibrato unit) (e.g., block “4” in (c) of FIG. 7) having the pitch shift in question is selected from the selected group of bend units (or the one vibrato unit), to generate rendition style information. Then, crossfade synthesis is performed between the preceding waveform to a new tone waveform (succeeding waveform) based on the generated rendition style information, to achieve smooth switching from the preceding waveform to the new tone waveform (succeeding waveform), in generally the same manner as set forth above. In the case where the input pitch modulation information is acquired constantly as noted above, it is only necessary to use a bend unit group (or one vibrato unit) corresponding to the already-acquired input dynamics value. For example, when the input pitch modulation information has changed, in a period between time t1 and t2, to one that designates a bend unit (or waveform data set of a partial section of the vibrato unit) (e.g., block “3” in (c) of FIG. 7), one of the bend units (or waveform data set of one of the partial sections of the vibrato unit), corresponding to the input dynamics value acquired at time t1, is selected. In this case, the input dynamics values acquired at the predetermined time intervals are of course stored in a buffer memory.

### EMBODIMENT 3

Next, a description will be given about the “auto vibrato body synthesis processing”, with reference to FIG. 8. FIG. 8 is a flow chart showing an example operational sequence of the “auto vibrato body synthesis processing”, which is also interrupt processing performed by the CPU 1, for example every one ms, in the electronic musical instrument in response to a start of a performance. The “auto vibrato body synthesis processing” is performed in a mode designated for synthesizing a sustain portion of a tone with an “auto vibrato body” characteristic in response to operation by the human player or in response to performance information or the like. Note that a waveform of an attack portion of the tone is generated separately by not-shown attack portion waveform synthesis processing, in a similar manner to the above-described. The “auto vibrato body synthesis processing” is performed following the attack portion waveform synthesis processing. In this “auto vibrato body synthesis processing”, a pitch (or note) of the tone to be generated is designated by note information, and a vibrato-imparted tone waveform is generated by automatically reproducing waveform data of a “vibrato unit” selected in accordance with the designated pitch and input dynamics value. Therefore, the “auto vibrato body synthesis processing” is useful in a case where a vibrato tone is to be generated on the basis of automatic performance data. In the “auto vibrato body synthesis processing”, a speed and depth of a vibrato tone to be reproduced on the basis of a “vibrato unit” can be variably controlled in accordance with respective control data, as will be later described in detail. Further, the entire vibrato tone can be shifted in pitch (or pitch-shifted) in accordance with pitch bend information. Further, in the “auto vibrato body synthesis processing”, the selection of a unit based on the input dynamics value is carried out each time reproduction of one cycle (e.g., one vibrato cycle) of a “vibrato unit” is completed, rather than in response to measurement of the predetermined time interval.

At step S21 of FIG. 8, a determination is made as to whether a currently-synthesized waveform (waveform of the attack portion) has reached the end of the attack portion, or whether a vibrato unit being used as a currently-synthesized sustain portion waveform has reached its end after the end of the attach portion was reached. If the currently-synthesized waveform has not yet reached the end of the attack portion, or if the vibrato unit being used has not yet reached its end (NO determination at step S21), the processing of FIG. 8 is brought to an end, and it will not be performed till the next interrupt timing. Namely, till the end of the attack portion, a tone of the attack portion is synthesized on the basis of the waveform data of the attack portion, without the auto vibrato body synthesis processing being substantially performed. Further, during the course of reproduction of one cycle of waveform data in a vibrato unit following the attack portion, substantial execution of the auto vibrato body synthesis processing is waited till the next interrupt timing (one ms later) without an operation for modifying the currently-reproduced vibrato unit being performed. Therefore, no waveform data (vibrato unit) switching responsive to the input dynamics value is not carried out during that time. On the other hand, if the currently-synthesized waveform has reached the end of the attack portion, or if the vibrato unit currently being used has reached its end (YES determination at step S21), the current latest input dynamics value is acquired at step S22. At step S23, the database is referenced, in accordance with the previously-acquired note information and the acquired input dynamics value, to select a corresponding vibrato unit from the database. At next step S24, the selected vibrato unit is processed on the basis of information, such as the input pitch bend information, vibrato speed and vibrato depth, to generate rendition style information. Here, the processing of the selected vibrato unit includes, for example, shifting the waveform pitch of the entire selected vibrato unit in accordance with the input pitch bend information, making a setting to increase/decrease the vibrato cycle in accordance with the input vibrato speed data and setting a vibrato depth in accordance with the input vibrato depth data, etc. Note that, in the illustrated example of FIG. 8, the operations of steps S24 and S25 are carried out only once when a YES determination has been made at step S21, and the acquisition of the information, such as the input pitch bend information, vibrato speed and vibrato depth, is carried out at the same timing as the acquisition of the input dynamics value. However, the present invention is not so limited; for example, variation in the information, such as the input pitch bend information, vibrato speed and vibrato depth, may be constantly checked so that auto vibrato settings may be modified at any time. In such a case, the operation of step S21 may be modified so as to check whether there has occurred variation in the input pitch bend information, vibrato speed, vibrato depth or other information after the end of the attack portion was reached and during reproduction of the vibrato unit, and the operational sequence may be modified so that the operation of step S24 is carried out once variation has occurred in the input pitch bend information, vibrato speed, vibrato depth or other information.

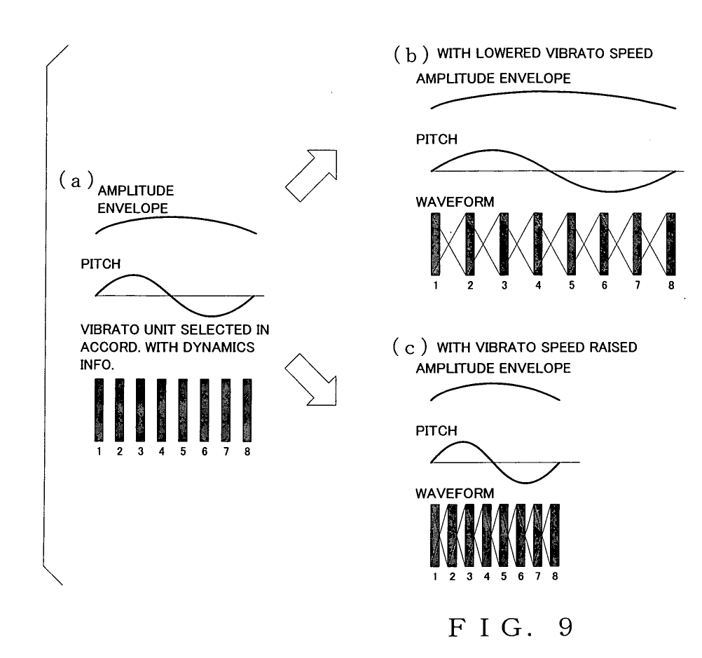

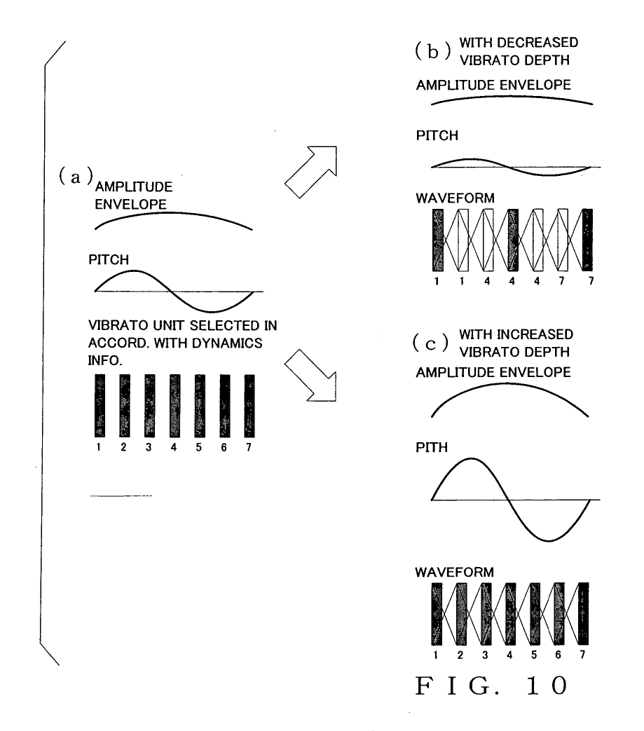

The following paragraphs describe in detail an example of the processing carried out at step S24 in the above-described “auto vibrato body synthesis processing” (see FIG. 8), in relation to a case where the vibrato speed is subjected to the processing (FIG. 9) and in relation to a case where the vibrato depth is subjected to the processing (FIG. 10).

FIG. 9 is a schematic diagram explanatory of a procedure for processing a vibrato speed of a vibrato unit in the “auto vibrato body synthesis processing”. More specifically, (a) of FIG. 9 shows an original vibrato unit selected in accordance with the previously-acquired note information and acquired input dynamics value, and it is assumed here a speed at which the original vibrato unit is reproduced as-is is used as a “basic vibrato speed”. (b) of FIG. 9 shows an example of a waveform synthesized with a vibrato speed lowered relative to the basic vibrato speed, and (c) of FIG. 9 shows an example of a waveform synthesized with a vibrato speed raised relative to the basic vibrato speed. To facilitate understanding, (a) of FIG. 9 also illustrates an original amplitude envelope and pitch variation of the waveform data of the original vibrato unit. Further, for reference purposes, (b) and (c) of FIG. 9 also illustrate an amplitude envelope expanded/compressed in a time-axis direction in accordance with increasing/decreasing adjustment of the vibrato speed, as well as pitch variation.

In (a) of FIG. 9, the original vibrato unit is shown as comprising waveform data sets of eight (partial) sections (section “1”-section “8”), and switching is sequentially made between the waveform data sets of the individual sections (“1”-“8”) at predetermined time intervals. Each of the switched-to (or selected) waveform data sets is read out repetitively over a plurality of cycles thereof, and the waveform data sets of adjoining ones of the sections are subjected to crossfade synthesis. In this case, the waveform data of each of the sections typically comprising data representing a waveform of one cycle but may comprise data representing a waveform of a plurality of cycles or less than one cycle, as noted above. If the vibrato speed is to be lowered (i.e., the vibrato period is to be made longer), crossfade synthesis is performed between the waveform data sets of the adjoining sections with the waveform-data-switching time intervals increased. Conversely, if the vibrato speed is to be raised (i.e., the vibrato period is to be made shorter), crossfade synthesis is performed between the waveform data sets of the adjoining sections with the waveform-data-switching time intervals decreased. In case a desired short vibrato period can not be achieved if the waveform data sets of all of the sections (“1”-“8”) in the vibrato unit are used, the waveform data of one or more appropriate ones of the sections may be thinned out.

The waveform to be synthesized may be set to have the same pitch and amplitude envelope as the original vibrato unit. Alternatively, an amplitude envelope and pitch variation envelope, having been subjected to time-axial expansion/compression control as illustrated in (b) or (c) of FIG. 9, may be generated separately, and the pitch and amplitude envelope of the waveform data sets to be crossfade synthesized may be further controlled in accordance with the thus-generated amplitude envelope and pitch variation envelope. Such time-axial expansion/compression control of the pitch and amplitude can be performed using the known technique proposed by the assignee of the instant application, and thus, a detailed description about the time-axial expansion/compression control of the pitch and amplitude is omitted.

FIG. 10 is a schematic diagram explanatory of a procedure for processing a vibrato depth of a vibrato unit in the “auto vibrato body synthesis processing”. More specifically, (a) of FIG. 10 shows an original vibrato unit selected in accordance with the previously-acquired note information and acquired input dynamics value, and it is also assumed here a depth at which the original vibrato unit is reproduced as-is is used as a “basic vibrato depth”. (b) of FIG. 10 shows an example of a waveform synthesized with a vibrato depth decreased relative to the basic vibrato depth, and (c) of FIG. 10 shows an example of a waveform synthesized with a vibrato depth increased relative to the basic vibrato depth. FIG. 10 shows the original vibrato unit as comprising waveform data of seven sections (section “1”-section “7”), as well as an amplitude envelope and pitch variation. If the vibrato depth of the vibrato unit is to be decreased, a waveform data set of a section representing a shallow or small pitch shift is selected from the vibrato unit, and a vibrato tone waveform of a shallow vibrato depth is synthesized by repeatedly using the selected waveform data set. For example, if the vibrato depth of a vibrate unit varying within a range of −50 cents through 0 cent to +50 cents is to be reduced by half, then a waveform data set of a pitch shift within a range of −25 cents through 0 cent to +25 cents is used; in this case, no waveform data of a greater pitch shift is used. In the illustrated example of (b) of FIG. 10, the waveform data set of the first, fourth and seventh sections, having pitches within the range of −25 cents through 0 cent to +25 cents, are selected from the vibrato unit and used for tone waveform synthesis, but the waveform data of the second, third, fifth and seventh sections, having pitch shifts greater than the range of −25 cents through 0 cent to +25 cents, are not used for tone waveform synthesis. Conversely, if the vibrato depth of the vibrate unit is to be increased, the waveform data sets of all of the sections in the vibrato unit are used, and control is performed to raise or lower the pitches of the individual sections in accordance with a pitch variation curve processed so as to increase the pitch shift. Alternatively, the vibrato unit may have prestored therein waveform data of various different (e.g., small and great) vibrato depths so that any desired waveform data sets can be selected and used (in combination, i.e. in an interpolated manner) in accordance with vibrato depth information; namely, if there is prestored no waveform data set corresponding to the input vibrato depth information, two waveform data sets of vibrato depths close to the input vibrato depth information may be selected, and then interpolation may be performed between the two selected waveform data sets to generate a waveform data set corresponding to the input vibrato depth information. When the vibrato depth has been decreased, amplitude envelope control may be performed such that the amplitude envelope has a decreased level variation width, while, when the vibrato depth has been increased, amplitude envelope control may be performed such that the amplitude envelope has an increased level variation width, as illustrated in (b) and (c) of FIG. 10.

In the present invention, which is characterized by acquiring input dynamics values intermittently at predetermined time intervals when a tone of a sustain portion (i.e., sustain tone portion) is to be generated, the predetermined time intervals need not necessarily be constant time intervals throughout generation of the tone. Namely, the time intervals may be varied appropriately, e.g. 20 ms intervals at the beginning, 30 ms intervals several interrupt timing later and 40 ms intervals another several interrupt timing later. Even with such varying time intervals, it is possible to achieve the objects and advantageous results of the present invention.

It should also be appreciated that the waveform data employed in the present invention may be of any desired type without being limited to those constructed as rendition style modules in correspondence with various rendition styles as described above. Further, the waveform data of the individual units may of course be either data that can be generated by merely reading out waveform sample data based on a suitable coding scheme, such as the PCM, DPCM or ADPCM, or data generated using any one of the various conventionally-known tone waveform synthesis methods, such as the harmonics synthesis operation, FM operation, AM operation, filter operation, formant synthesis operation and physical model tone generator methods. Namely, the tone generator 8 in the present invention may employ any of the known tone signal generation methods such as: the memory readout method where tone waveform sample value data stored in a waveform memory are sequentially read out in accordance with address data varying in response to the pitch of a tone to be generated; the FM method where tone waveform sample value data are acquired by performing predetermined frequency modulation operations using the above-mentioned address data as phase angle parameter data; and the AM method where tone waveform sample value data are acquired by performing predetermined amplitude modulation operations using the above-mentioned address data as phase angle parameter data. Namely, the tone signal generation method employed in the tone generator 8 may be any one of the waveform memory method, FM method, physical model method, harmonics synthesis method, formant synthesis method, analog synthesizer method using a combination of VCO, VCF and VCA, analog simulation method, and the like. Further, instead of constructing the tone generator 8 using dedicated hardware, the tone generator circuitry 8 may be constructed using a combination of the DSP and microprograms or a combination of the CPU and software. Furthermore, a plurality of tone generation channels may be implemented either by using a single circuit on a time-divisional basis or by providing a separate dedicated circuit for each of the channels.

Further, the present invention is not limited to the arrangements that waveform data sets, each comprising a plurality of sections of different pitches, are stored as individual vibrato units in the database as described in relation to the “auto vibrato body synthesis processing” (i.e., third embodiment described above in relation to FIG. 8). Instead of such vibrato units, other appropriate units of pitch-varying tone waveforms (e.g., tone waveforms of a trill rendition style) may be stored in the database.

Further, the tone synthesis method in the above-described tone synthesis processing may be either the so-called playback method where existing performance information is acquired in advance prior to arrival of an original performance time and a tone is synthesized by analyzing the thus-acquired performance information, or the real-time method where a tone is synthesized on the basis of performance information supplied in real time.

Further, the method employed in the present invention for connecting together waveforms of a plurality of units sequentially selected and generated in a time-serial manner is not limited to the crossfade synthesis and may, for example, be a method where waveforms of generated units are mixed together via a fader means.

Furthermore, in the case where the above-described tone synthesis apparatus of the present invention is applied to an electronic musical instrument, the electronic musical instrument may be of any type other than the keyboard instrument type, such as a stringed, wind or percussion instrument type. The present invention is of course applicable not only to the type of electronic musical instrument where all of the performance operator unit, display, tone generator, etc. are incorporated together within the body of the electronic musical instrument, but also to another type of electronic musical instrument where the above-mentioned components are provided separately and interconnected via communication facilities such as a MIDI interface, various networks and/or the like. Further, the tone synthesis apparatus of the present invention may comprise a combination of a personal computer and application software, in which case various processing programs may be supplied to the tone synthesis apparatus from a storage medium, such as a magnetic disk, optical disk or semiconductor memory, or via a communication network. Furthermore, the tone synthesis apparatus of the present invention may be applied to automatic performance apparatus, such as karaoke apparatus and player pianos, game apparatus, and portable communication terminals, such as portable telephones. Further, in the case where the tone synthesis apparatus of the present invention is applied to a portable communication terminal, part of the functions of the portable communication terminal may be performed by a server computer so that the necessary functions can be performed cooperatively by the portable communication terminal and server computer. Namely, the tone synthesis apparatus of the present invention may be arranged in any desired manner as long as it can use predetermined software or hardware, arranged in accordance with the basic principles of the present invention, to synthesize a tone while appropriately selecting each unit to be used by switching between normal or vibrato units stored in the database.

What is claimed is:

1. A tone synthesis apparatus comprising:
a storage section that stores therein waveform data sets for sustain tones in association with dynamics values;
an acquisition section that, when a sustain tone is to be generated, acquires, intermittently at predetermined time intervals, dynamics values for controlling the sustain tone to be generated; and
a tone generation section that acquires, from said storage section, the waveform data set corresponding to the dynamics value acquired by said acquisition section and generates a tone waveform of the sustain tone on the basis of the acquired waveform data set.

2. A tone synthesis apparatus as claimed in claim 1 wherein said storage section stores therein, for each tone pitch or for each pitch range, units or waveform data sets in association with the dynamics values.

3. A tone synthesis apparatus comprising:
a storage section that stores therein a plurality of units, each including a plurality of waveform data sets corresponding to different pitch shifts, in association with dynamics values;
a dynamics value acquisition section that acquires, intermittently at predetermined time intervals, dynamics values for controlling a tone to be generated;
a pitch modulation information acquisition section that acquires pitch modulation information for controlling pitch modulation of the tone to be generated; and
a tone generation section that selects, from said storage section, the unit corresponding to the dynamics value acquired by said acquisition section, acquires, from the selected unit, the waveform data set corresponding to the pitch modulation information acquired by said pitch modulation information acquisition section, and generates a tone waveform on the basis of the acquired waveform data set.

4. A tone synthesis apparatus as claimed in claim 3 wherein said storage section stores therein, for each tone pitch or for each pitch range, units or waveform data sets in association with the dynamics values.

5. A tone synthesis apparatus comprising:
a storage section that stores therein a plurality of units, each including a plurality of waveform data sets for achieving a characteristic to cause variation in pitch over time, in association with dynamics values;
an acquisition section that, when a tone with a characteristic to cause variation in pitch over time is to be generated, acquires dynamics values for controlling the tone to be generated; and
a tone generation section that acquires, from said storage section, the waveform data sets of the unit corresponding to the dynamics value acquired by said acquisition section and generates, on the basis of the acquired waveform data sets, a tone waveform with a characteristic to cause variation in pitch over time.

6. A tone synthesis apparatus as claimed in claim 5 wherein the unit includes a plurality of waveform data sets for achieving a vibrato characteristic.

7. A tone synthesis apparatus as claimed in claim 5 wherein said storage section stores therein, for each tone pitch or for each pitch range, units or waveform data sets in association with the dynamics values.

8. A tone synthesis apparatus comprising:
a storage section that stores therein a unit including a plurality of waveform data sets for achieving a vibrato characteristic to cause variation in pitch over time;
an acquisition section that acquires depth control information for controlling a vibrato depth;
a tone generation section that acquires, from said storage section, the plurality of waveform data sets of the unit and generates a tone waveform with a vibrato characteristic on the basis of the acquired plurality of waveform data sets of the unit and the depth control information acquired by said acquisition section, wherein, when control is to be performed to decrease the vibrato depth in accordance with the acquired depth control information, said tone generation section generates the tone waveform without using waveform data, corresponding to a great pitch shift, of the plurality of waveform data sets of the unit.

9. A method for synthesizing a tone using a computer and a memory storing therein waveform data sets for sustain tones in association with dynamics values, said method comprising:
a step of, when a sustain tone is to be generated, acquiring, intermittently at predetermined time intervals, dynamics values for controlling the sustain tone to be generated; and
a step of acquiring, from the memory, the waveform data set corresponding to the acquired dynamics value and generating a tone waveform of the sustain tone on the basis of the acquired waveform data set.

10. A method for synthesizing a tone using a computer and a memory storing therein a plurality of units, each including a plurality of waveform data sets corresponding to different pitch shifts, in association with dynamics values, said method comprising:
a step of acquiring, intermittently at predetermined time intervals, dynamics values for controlling a tone to be generated;
a step of acquiring pitch modulation information for controlling pitch modulation of the tone to be generated; and
a step of selecting, from the memory, the unit corresponding to the acquired dynamics value, then acquiring, from the selected unit, the waveform data set corresponding to the acquired pitch modulation information, and then generating a tone waveform on the basis of the acquired waveform data set.

11. A method for synthesizing a tone using a computer and a memory storing therein a plurality of units, each including a plurality of waveform data sets for achieving a characteristic to cause variation in pitch over time, in association with dynamics values, said method comprising:
a step of, when a tone with a characteristic to cause variation in pitch over time is to be generated, acquiring dynamics values for controlling the tone to be generated; and
a step of acquiring, from the memory, the waveform data sets of the unit corresponding to the acquired dynamics value and generating, on the basis of the acquired waveform data sets, a tone waveform with a characteristic to cause variation in pitch over time.

12. A method for synthesizing a tone using a computer and a memory storing therein a unit including a plurality of waveform data sets for achieving a vibrato characteristic to cause variation in pitch over time, said method comprising:
a step of acquiring depth control information for controlling a vibrato depth;
a tone generation step of acquiring, from the memory, the waveform data sets of the unit and generating a tone waveform with a vibrato characteristic on the basis of the acquired plurality of waveform data sets of the unit and the acquired depth control information, wherein, when control is to be performed to decrease the vibrato depth in accordance with the acquired depth control information, said tone generation step generates the tone waveform without using waveform data, corresponding to a great pitch shift, of the plurality of waveform data sets of the unit.

13. A program containing a group of instructions to cause a computer to perform a tone synthesis procedure using a memory storing therein waveform data sets for sustain tones in association with dynamics values, said tone synthesis procedure comprising:
a step of, when a sustain tone is to be generated, acquiring, intermittently at predetermined time intervals, dynamics values for controlling the sustain tone to be generated; and
a step of acquiring, from the memory, the waveform data set corresponding to acquired dynamics values and generating a tone waveform of the sustain tone on the basis of the acquired waveform data set.

14. A program containing a group of instructions to cause a computer to perform a tone synthesis procedure using a memory storing therein a plurality of units, each including a plurality of waveform data sets corresponding to different pitch shifts, in association with dynamics values, said tone synthesis procedure comprising:
a step of acquiring, intermittently at predetermined time intervals, dynamics values for controlling a tone to be generated;
a step of acquiring pitch modulation information for controlling pitch modulation of the tone to be generated; and
a step of selecting, from the memory, the unit corresponding to the acquired dynamics value, then acquiring, from the selected unit, the waveform data set corresponding to the acquired pitch modulation information, and then generating a tone waveform on the basis of the acquired waveform data set.

15. A program containing a group of instructions to cause a computer to perform a tone synthesis procedure using a memory storing therein a plurality of units, each including a plurality of waveform data sets for achieving a characteristic to cause variation in pitch over time, in association with dynamics values, said tone synthesis procedure comprising:
a step of, when a tone with a characteristic to cause variation in pitch over time is to be generated, acquiring dynamics values for controlling the tone to be generated; and
a step of acquiring, from the memory, the waveform data sets of the unit corresponding to the acquired dynamics values and generating, on the basis of the acquired waveform data sets, a tone waveform with a characteristic to cause variation in pitch over time.

16. A program containing a group of instructions to cause a computer to perform a tone synthesis procedure using a computer and a memory storing therein a unit including a plurality of waveform data for achieving a vibrato characteristic to cause variation in pitch over time, said tone synthesis procedure comprising:
a step of acquiring depth control information for controlling a vibrato depth;
a tone generation step of acquiring, from the memory, the waveform data sets of the unit and generating a tone waveform with a vibrato characteristic on the basis of the acquired plurality of waveform data sets of the unit and the acquired depth control information, wherein, when control is to be performed to decrease the vibrato depth in accordance with the acquired depth control information, said tone generation step generates the tone waveform without using waveform data, corresponding to a great pitch shift, of the plurality of waveform data sets of the unit.
